(19) United States
(12) Patent Application Publication
(10) Pub. No.: US 2013/0063099 A1
(43) Pub. Date: Mar. 14, 2013

(54) High electrical field driver

(71) Applicants: Yen-Wei Hsu, Taipei (TW); Whei-Chyou Wu, Fremont, CA (US)

(72) Inventors: Yen-Wei Hsu, Taipei (TW); Whei-Chyou Wu, Fremont, CA (US)

(21) Appl. No.: 13/229,726

(22) Filed: Sep. 11, 2011

(51) Int. Cl. G05F 1/30

(52) U.S. Cl. 323/223

(57) ABSTRACT

A high electrical field driver for producing high electrical field is invented based on the switching circuit. The inventive high electrical field driver can produce at least one high electrical field.

### FIELD OF INVENTION

This invention relates to a driver, more particularly, to a high electrical field driver for producing at least one high electrical field.

### BACKGROUND INFORMATION

Conventionally, there are a number of known voltage regulating circuits, for example, a boost circuit for boosting voltage level and a buck circuit for reducing voltage level. FIG. 1a has shown a known boost circuit.

The boost circuit of FIG. 1a has shown an electrical power source 109, an inductor 101, a switch such as a power transistor 103, a PWM controller 104 for controlling the on/off switching of the power transistor 103 and a loading 108. The electrical power source 109, the inductor 101 and the power transistor 103 are electrically connected in series with each other and the loading 108 is electrically connected to a low side of the inductor 101. Please note that a diode 107 is for keeping current flow in one direction.

FIG. 1i has shown a known blocking oscillator which can be divided into a first circuit 128 marked by a dotted block and a second circuit not in the first circuit electrically coupling with the first circuit 128. The second circuit formed by an electrical power source 120, a second inductor 124, a second resistor 122 which is the resistance of the second inductor 124, a switch such as a transistor 125 and a driven loading 127 electrically connected to a low side of the second inductor 124. The electrical power source 120, the second inductor 124, the transistor 125 are electrically connected in series with each other.

The first circuit 128 and the second circuit are powered by the electrical power source 120. The first circuit 128 is formed by a first resistor 121, a first inductor 123 forming a transformer with the second inductor 124 as a disturbance to the blocking oscillator, and a capacitor 126 oscillates the power transistor 125 of the second circuit so that the transistor 125 oscillated by the first circuit 128 can be viewed as a self-excitation switch and the blocking oscillator of FIG. 1i can be viewed as a self-excitation oscillator. Obviously, the first circuit 128 and the second circuit use the same electrical power source 120 and the first circuit 128 is a RLC circuit good for oscillation and the charge and the discharge of the capacitor 126 of the first circuit 128 switch the transistor 125.

The boost circuit of FIG. 1a and the blocking oscillator of FIG. 1i have a “switching circuit” in common. The switching circuit comprises an electrical power source for providing an electrical energy, an inductor for temporarily storing magnetic energy converted from the electrical energy of the electrical power source, and a switch or a frequency modulator for providing frequency-modulation to the switching circuit electrically connected in series with each other. The sequence of the electrical power source, the inductor and the frequency modulator of the switching circuit is not limited in the switching circuit. Please note that the on/off switching of the power transistor 109 of FIG. 1a is controlled by a “given signal” provided by the PWM controller 104, but the transistor 125 of the second circuit of FIG. 1i is a self-excitation switch.

The switching circuit describes converting an electrical energy of the electrical power source into a magnetic energy temporarily stored in the inductor and releasing the magnetic energy temporarily stored in the inductor into current controlled by the oscillation of the frequency modulator. By using the boost circuit of FIG. 1a as an example, when the power transistor 103 is in close state (the power transistor 103 is on), a current from the electrical power source 109 flowing through the switching circuit magnetizes the inductor 102 converting an electrical energy from the electrical power source 109 into a magnetic energy temporarily stored in the inductor 101; and when the power transistor 103 is in open state (the power transistor 103 is off), current from the electrical power source 109 stops and the magnetic energy temporarily stored in the inductor 101 will be immediately released in the form of a current for driving the loading 108. Obviously, converting the electrical energy from the electrical power source 109 into the magnetic energy stored in the inductor 101 and releasing the magnetic energy temporally stored in the inductor 101 into current for driving the loading 108 is realized by the switchings of the power transistor 103. For example, if the power transistor 103 is always on, then the magnetic energy converted by the electrical energy of the electrical power source 109 will be continuously stored in the inductor 101 against releasing until the power transistor 103 is turned off.

The sequence of the electrical power source, the inductor and the frequency modulator of the switching circuit is not limited in the switching circuit so that the frequency modulator can be disposed at the high side or the low side of the inductor as respectively shown in FIG. 1b or 1c. The switching circuit of FIG. 1b or 1c in a general form comprises an electrical power source 159 for providing electrical energy, an inductor 151 for temporarily storing magnetic energy converted by the electrical energy from the electrical power source 159, and a frequency modulator 153 for frequency-modulating the switching circuit electrically connected in series with each other.

The frequency modulator 153 is not limited, for example, it can be a self-excitation switch as explained by FIG. 1i or an electronic switch such as a transistor controlled by a waveform from the PWM controller as shown in FIG. 1a. FIG. 1d has shown the switching circuit of FIG. 1b with the frequency modulator 153 realized by a switch 1534 comprising a first terminal, a second terminal and a third terminal of which the electrical connection or disconnection of the first terminal and the second terminal respectively marked by 1 and 2 are controlled by a signal received on its third terminal marked by 3. The inductor 151 is not limited, for example, it can be the inductor revealed in our previous invention Ser. No. 13/193,620 of USA. The electrical power source 159 is not limited, for example, it can be a dc power source such as a battery, a capacitor, a photo-electricity conversion device such as a solarcell.

By using the switching circuit of FIG. 1b and assuming the frequency modulator 153 of the switching circuit of FIG. 1b to be a transistor, current from the electrical power source 159 will flow through the inductor 151, the transistor 153 in close state and to the ground. When the transistor 153 is turned open the current is cut off and a high Lenz voltage is produced at the opened point of the transistor 153. The high frequency ac Lenz current produced by the Lenz voltage is opposite to the current from the electrical power source 159 and hard to go through the inductor 151 back to the electrical power source 159 because the impedance of the inductor 151 becomes very big due to the high frequency excitation of the Lenz current so that a circuit, which is called “reaction circuit”, in parallel with the inductor 151 is for the opposite Lenz current to go through.

For any circuit, a power source applies power to a loading is an “action” and when the action stops “a reaction to the action” occurs. For example, by employing the switching circuit of FIG. 1b, when the power transistor 153 is in close state a current from the electrical power source 159 flowing through loadings, which include the inductor 151 and the transistor 153, is an “action” and when the transistor 153 is switched in open state the current from the electrical power source 159 is cut off at the transistor 153, the “action” stops, and an ac Lenz current, which is a reaction to the action, is expected to flow through the reaction circuit. An action/reaction isolation device is used to prohibit an action, which is the current from the electrical power source 159, to flow through the reaction circuit and allow a reaction to the action, which is the Lenz current opposite to the current from the electrical power source 159 to flow through the reaction circuit.

The reaction circuit shown in FIG. 1b comprises a damper 1512 and an action/reaction isolation device 1511 electrically connected in series with each other.

The action/reaction isolation device 1511 is used to prohibit an action, which is the current from the electrical power source 159, to flow through the reaction circuit and allow a reaction to the action, which is the Lenz current opposite to the current from the electrical power source 159 to flow through the reaction circuit.

The action/reaction isolation device 1511 is not limited, for example, an embodiment by using FIG. 1b, 1f the electrical power source 159 in FIG. 1b is a dc power source, the action/reaction isolation device can be an ac/dc isolation device such as a capacitor which can block the dc current from the dc power source from flowing through the reaction circuit but allow the opposite ac Lenz current to go through the reaction circuit. Another embodiment, the action/reaction isolation device can be an unidirectional device such as a diode for only allowing current to flow in one way. The unidirectional diode such as a diode prohibits current from the electrical power source flowing through the reaction circuit but allows the opposite Lenz current to flow through the reaction circuit.

The damper 1512 is for dissipating or stabilizing the Lenz power flowing through the reaction circuit and the damper is not limited. The damper 356 can be realized by a positive differential resistance device or PDR device in short and a negative differential resistance device or NDR device in short electrically connected in series. The following is a brief discussion about this.

For any RLC circuit can be expressed by two first-order differential equations as followed:

$$\{ \begin{matrix}\frac{d x}{d t} = y - F ( x ) \\ \frac{d y}{d t} = - g ( x )\end{matrix} \qquad ( 1 )$$

of which x and y are state variables of which one is current and the other one is voltage and F(x) is the impedance function. The two first-order differential equations (1) can be expressed by a secondorder differential equation as shown by:

$$\frac{{d}^{2} x}{d {t}^{2}} + \frac{d F ( x )}{d x} \frac{d x}{d t} + g ( x ) = 0$$

$$or$$

$$\frac{{d}^{2} x}{d {t}^{2}} + f ( x ) \frac{d x}{d t} + g ( x ) = 0$$

$$where$$

$$f ( x ) = \frac{d F ( x )}{d x}$$

Please not that the

$$\frac{d F ( x )}{d x}$$

in

$$\frac{d x}{d t}$$

terms is the damping term. According to the Liénard stabilized system theory, for any stabilized periodical system,

$$\frac{d F ( x )}{d x} > 0 and \frac{d F ( x )}{d x} < 0$$

hold simultaneously and the two must pass

$$\frac{d F ( x )}{d x} = 0 ,$$

where

$$\frac{d F ( x )}{d x} > 0$$

is defined as positive differential resistance or PDR in short,

$$\frac{d F ( x )}{d x} < 0$$

is defined as negative differential resistance or NDR in short, and

$$\frac{d F ( x )}{d x} = 0$$

is a constant resistance or defined as pure resistance. Any device having PDR is a PDR device, any device having NDR is a NDR device, and any device having constant resistance is defined as pure resistor. It's obvious that a PDR device and a NDR device electrically connected in series can satisfy

$$\frac{d F ( x )}{d x} > 0 and \frac{d F ( x )}{d x} < 0$$

simultaneously so that a PDR device and a NDR device electrically connected in series is a damper.

The PDR device and the NDR device are not limited, for example, an embodiment, a PDR device and a NDR device can respectively be a positive temperature coefficient or PTC in short and negative temperature coefficient or NTC in short. According to the chain-rule,

$$\frac{d F ( x )}{d x} = \frac{d F}{d T} \frac{d T}{d x}$$

where T is temperature and assuming the state x is current for the purpose of connivance,

$$\frac{d T}{d x}$$

can be interpreted as a change in current leads to a change in temperature, and the change in temperature leads to a change in resistance as described by

$$\frac{d F}{d T} .$$

This is the reason why the PDR device and the NDR device can respectively a PTC and a NTC.

More detailed about the discussion of the PDR device, the NDR device and it's damping effect can be referred to our previous invention “a capacitor” USA earily publication no. US2010-0277392A1 which talked about the PDR device, the NDR device and an energy discharge capacitor having the PDR device and the NDR device. The brief discussion above can be helpful to easier understand those.

FIG. 1e has shown the switching circuit of FIG. 1b of which the action/reaction isolation device is realized by a capacitor 15117 and the damper is realized by a PDR device 15126 and a NDR device 15127 electrically connected in series, and the capacitor 15117, the PDR device 15126 and the NDR device 15127 can be realized by an energy discharge capacitor having the PDR device and the NDR device. FIG. 1f has shown the switching circuit of FIG. 1b of which the action/reaction isolation device is realized by a diode 15118 and the damper is realized by a PDR device 15126 and a NDR device 15127 electrically connected in series. FIG. 1g has shown the switching circuit of FIG. 1e of which the PDR device 15126 and the NDR device 15127 are respectively substituted by a PTC 15128 and a NTC 15129. FIG. 1h has shown the switching circuit of FIG. 1g of which the frequency modulator is realized by a transistor 1530 switched by a positive on-duty waveform 1535 or a negative on-duty waveform 1536. FIG. 1j has shown the switching circuit of FIG. 1b of which the action/reaction isolation device 1511 and the damper 1512 are realized by an energy discharge capacitor 15118 of our previous invention.

### SUMMARY OF THE INVENTION

A high electrical field driver for producing high electrical field is invented based on the switching circuit. The inventive high electrical field driver can produce at least one high electrical field and Lenz problem can be solved by the presented invention. The inventive high electrical field driver can also produce multiple high electrical fields each of which can have single polarity and the multiple high electrical fields produced by a high electrical field driver can have different polarities.

### BRIEF DESCRIPTION OF THE DRAWINGS

FIG. 1a has shown a conventional boost circuit;

FIG. 1b has shown a switching circuit in a general form;

FIG. 1c has shown a switching circuit in a general form;

FIG. 1d has shown the switching circuit of FIG. 1b of which the frequency modulator is realized by a switch;

FIG. 1e has shown the switching circuit of FIG. 1b of which the action/reaction isolation device is realized by a capacitor and the damper is realized by a PDR device and a NDR device electrically connected in series;

FIG. 1f has shown the switching circuit of FIG. 1b of which the action/reaction isolation device is realized by a diode and the damper is realized by a PDR device and a NDR device electrically connected in series;

FIG. 1g has shown the switching circuit of FIG. 1e of which the PDR device and the NDR device are respectively substituted by a PTC and a NTC;

FIG. 1h has shown the switching circuit of FIG. 1g of which the frequency modulator is realized by a transistor switched by a positive on-duty waveform or a negative on-duty waveform;

FIG. 1i has shown a known blocking oscillator;

FIG. 1j has shown the switching circuit of FIG. 1b of which the action/reaction isolation device and the damper are realized by an energy discharge capacitor of our previous invention;

FIG. 2a has shown a high electrical field driver;

FIG. 2b has shown a high electrical field driver;

FIG. 2c has shown the high electrical field driver of FIG. 1a with a npn type transistor;

FIG. 2d has shown the high electrical field driver of FIG. 1b with a npn type transistor;

FIG. 2e has shown the high electrical field driver of FIG. 1a with a pnp type transistor;

FIG. 2f has shown a high electrical field driver with a npn type transistor having four high electrical fields;

FIG. 2g has shown a high electrical field driver with a pnp type transistor having four high electrical fields;

FIG. 2h has shown each high electric field of the high electrical field driver of FIG. 2f driving an open circuit device;

FIG. 2i has shown each high electric field of the high electrical field driver of FIG. 2g driving an open circuit device;

FIG. 2j has shown the high electrical field driver of FIG. 1b with a pnp type transistor;

FIG. 3a has shown an open circuit device; and

FIG. 3b has shown an open circuit device.

### DETAILED DESCRIPTION OF THE INVENTION

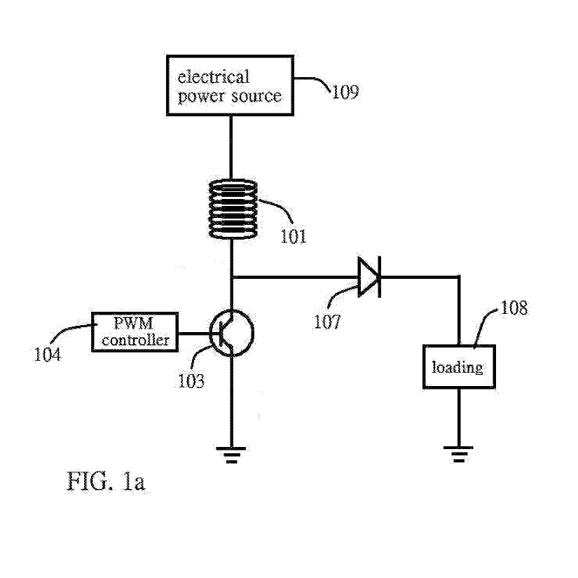

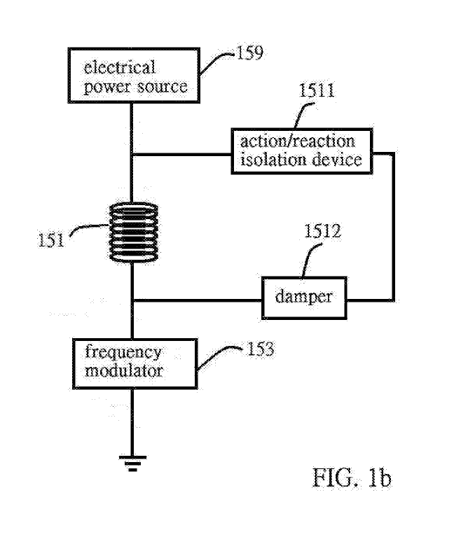

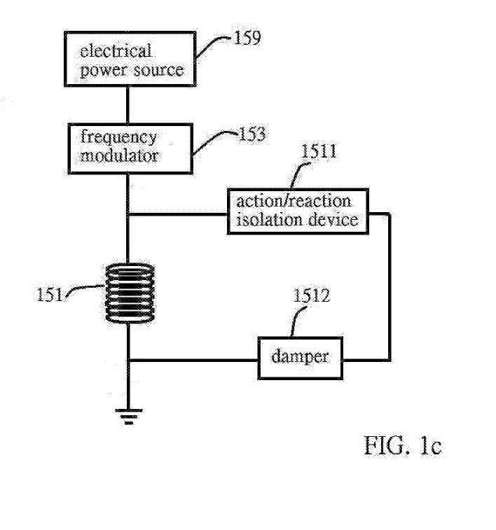

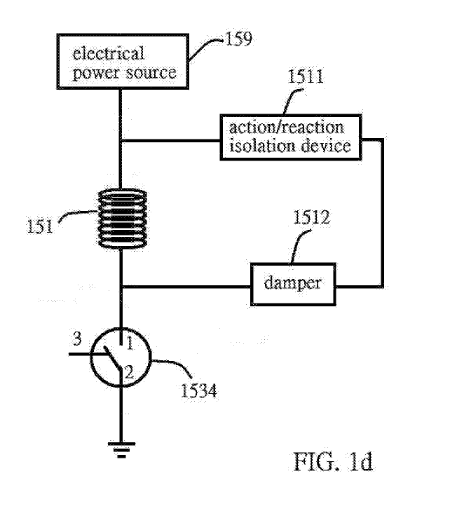

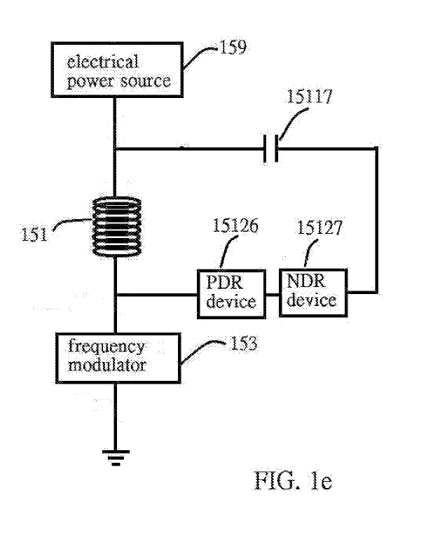

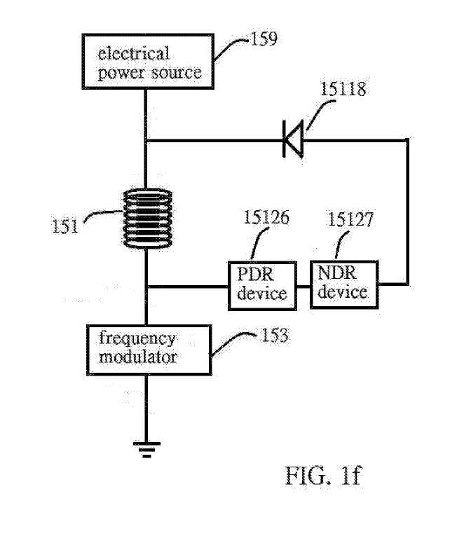

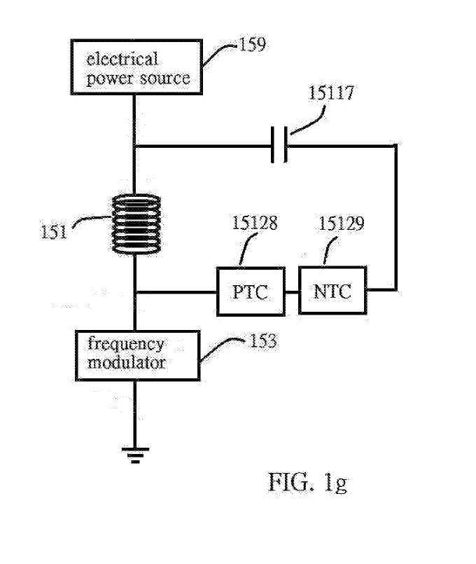

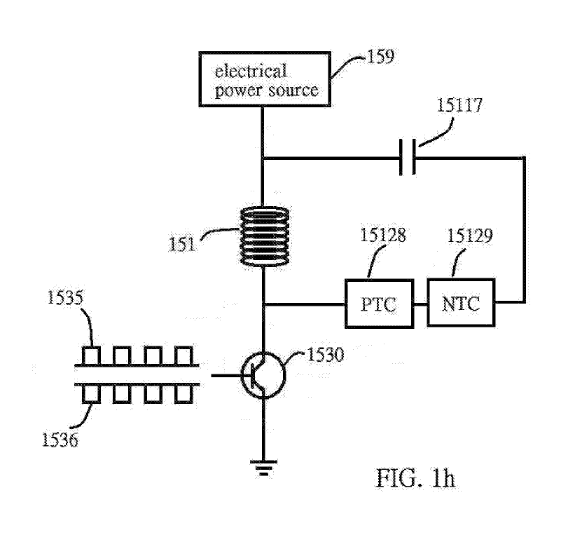

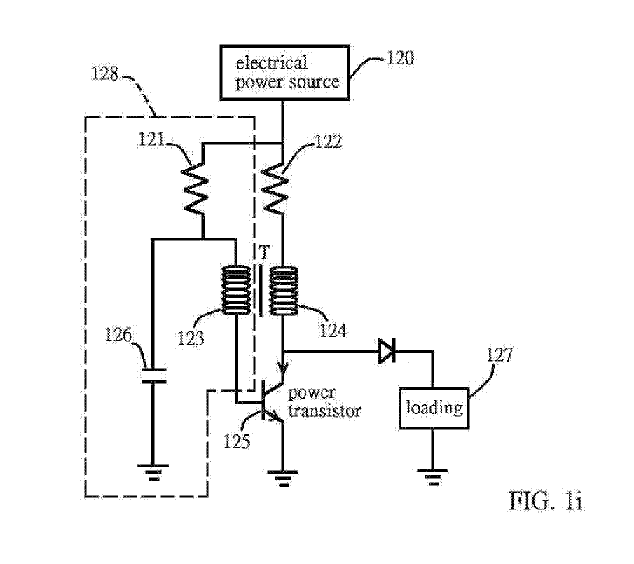

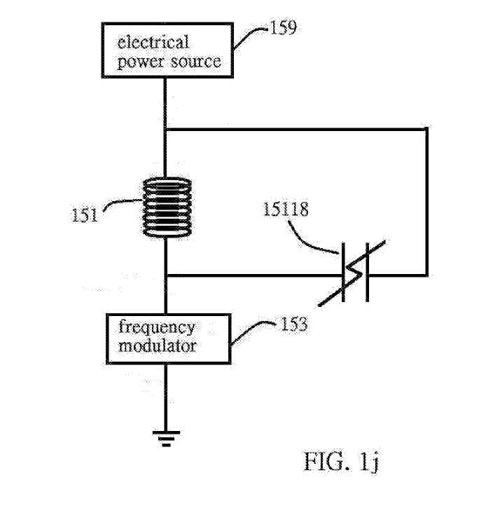

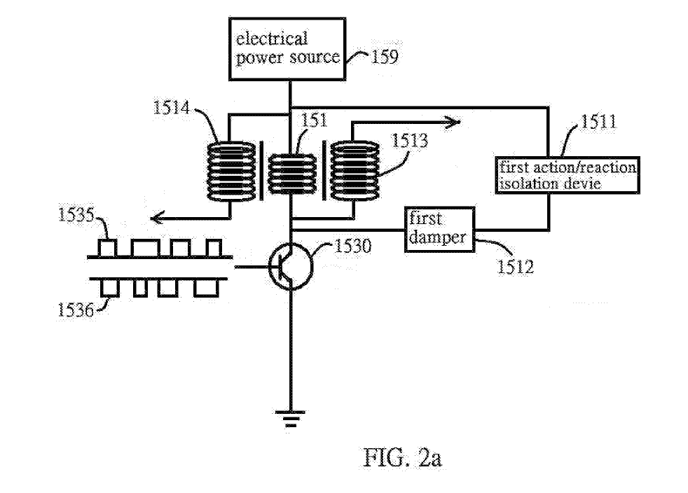

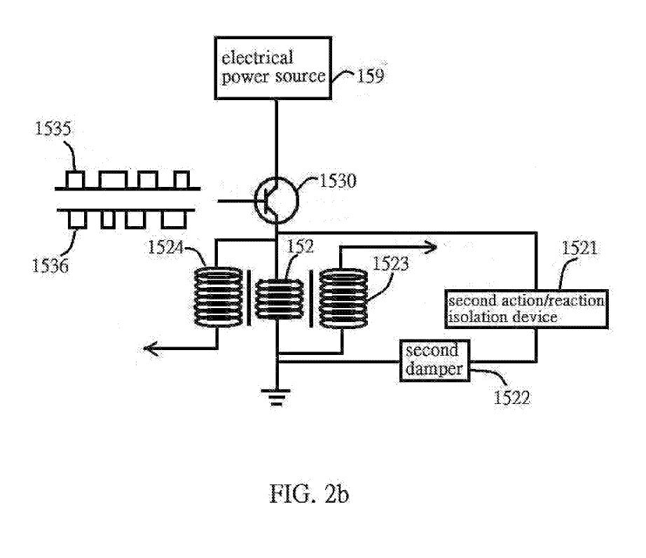

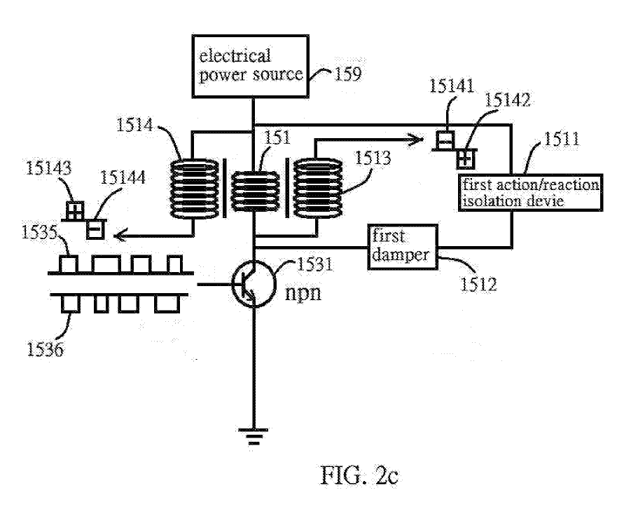

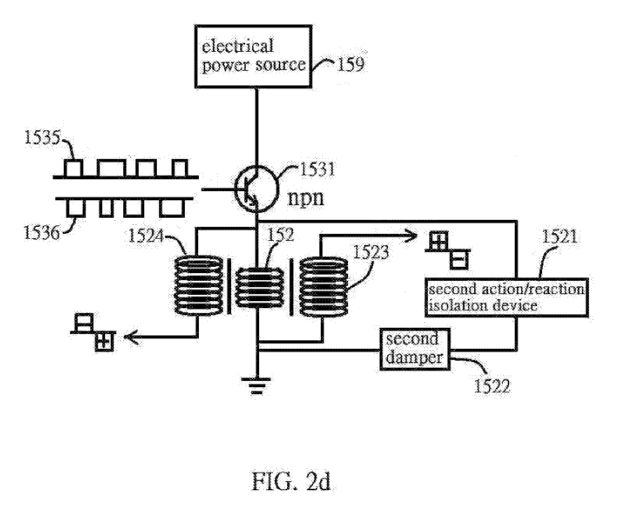

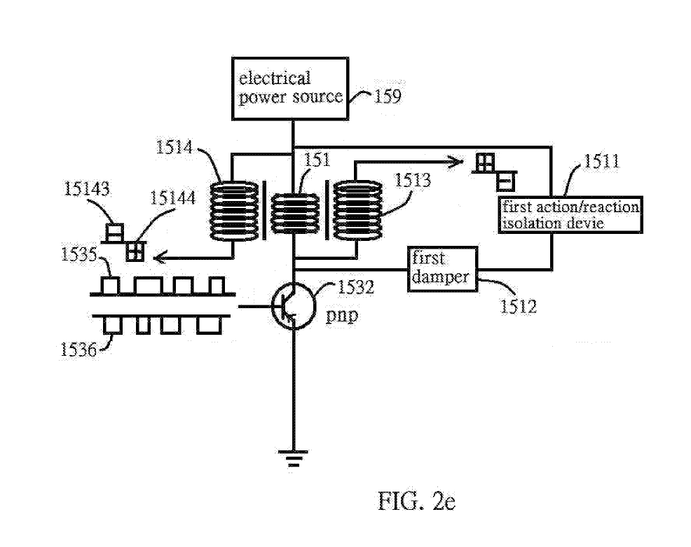

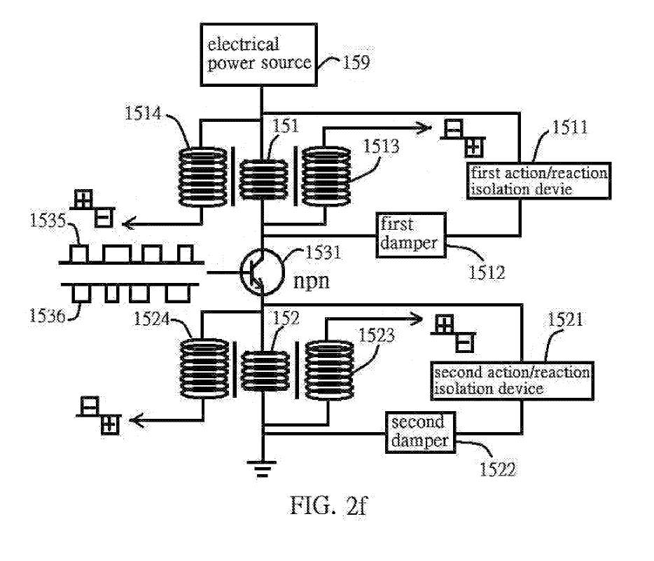

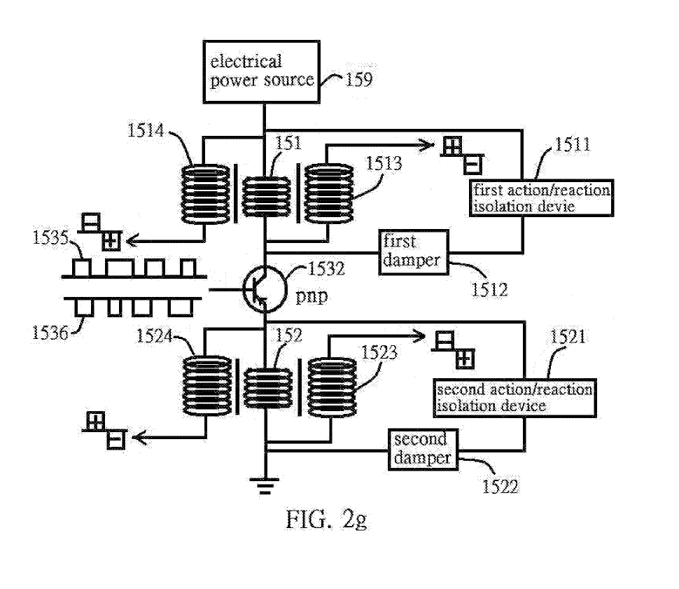

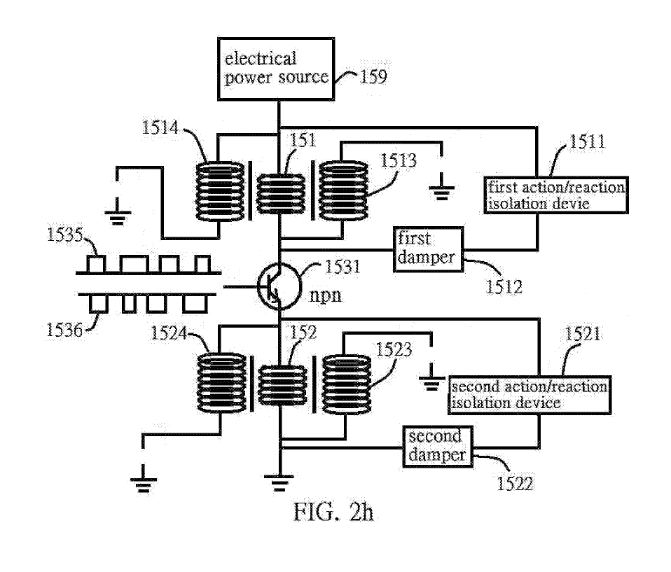

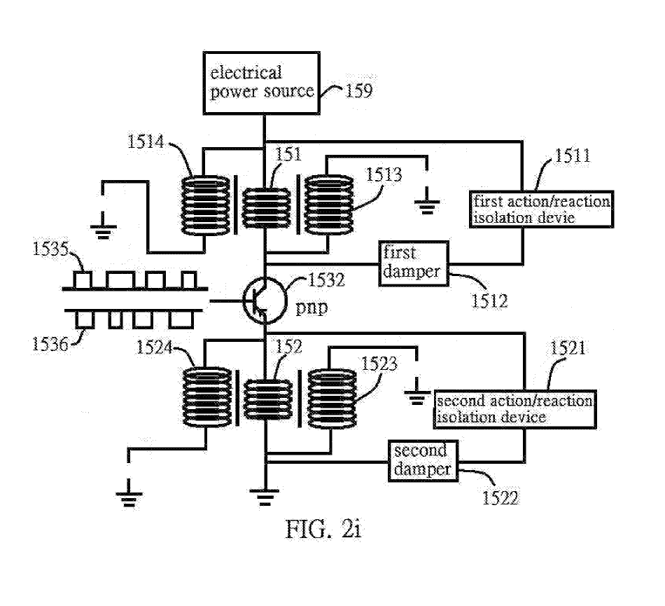

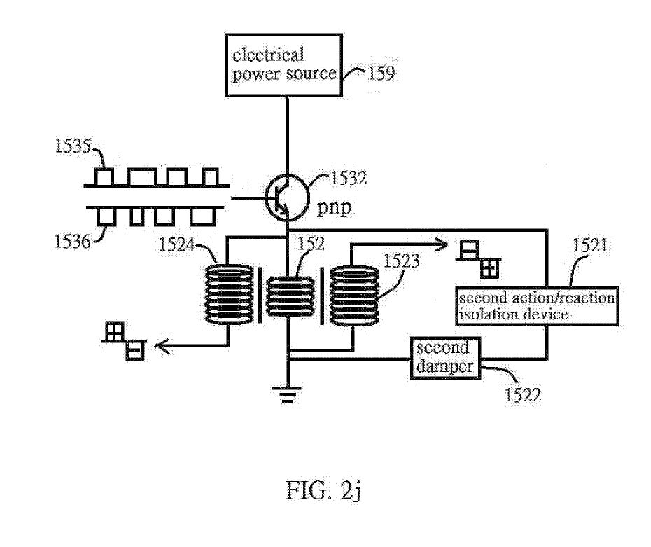

A high electrical field driver can be constructed by the switching circuit of FIG. 1b or FIG. 1c. Based on the switching circuit of FIG. 1b, for the purpose of convenience, assuming the frequency modulator to be a transistor switched by a positive on-duty waveform or a negative on-duty waveform, an embodiment of a first high electrical field driver shown in FIG. 2a has shown a positive on-duty waveform 1535 or a negative on-duty waveform 1536 switching a transistor 1530.

The first high electrical field driver shown in FIG. 2a has shown a third inductor 1513 forms a transformer with the first inductor 151 for boosting voltage to an expective level and a first terminal of the third inductor 1513 electrically connects with a low side terminal of the first inductor 151 and a first high electrical field with a single polarity or a first polarity can be obtained at a second terminal of the third inductor 1513.

A fourth inductor 1514 forms a transformer with the first inductor 151 for boosting voltage to an expective level and a first terminal of the fourth inductor 1514 electrically connects with a high side terminal of the first inductor 151 and a second high electrical field with a single polarity or a second polarity opposite to the first polarity can be obtained at a second terminal of the fourth inductor 1514. The first high electrical field driver has featured to produce two high electrical fields with opposite polarities.

Based on the switching circuit of FIG. 1c, for the purpose of convenience, assuming the frequency modulator to be a transistor switched by a positive on-duty waveform or a negative on-duty waveform, an embodiment of a second high electrical field driver shown in FIG. 2b has shown a positive on-duty waveform 1535 or a negative on-duty waveform 1536 switching a transistor 1530.

The second high electrical field driver shown in FIG. 2b has shown a fifth inductor 1523 forms a transformer with a second inductor 152 for boosting voltage to an expective level and a first terminal of the fifth inductor 1523 electrically connects with a low side terminal of the second inductor 152 and a third high electrical field with a single polarity or a third polarity can be obtained at a second terminal of the fifth inductor 1523, and a sixth inductor 1524 forms a transformer with the second inductor 152 for boosting voltage to an expective level and a first terminal of the sixth inductor 1524 electrically connects with a high side terminal of the second inductor 152 and a fourth high electrical field with a single polarity or a fourth polarity opposite to the third polarity can be obtained at a second terminal of the sixth inductor 1524. The second high electrical field driver has featured to produce two high electrical fields with opposite polarities.

The first, second, third and fourth polarities are also decided by the type of the transistor as pnp or npn type transistor and a waveform such as a positive on-duty waveform or a negative on-duty waveform to control the on/off switching of the transistor.

FIG. 2c has shown the embodiment of FIG. 2a by assigning the transistor as a npn transistor 1531 switched by the positive on-duty waveform 1535 or the negative on-duty waveform 1536 and FIG. 2d has shown the embodiment of FIG. 2b by assigning the transistor as a npn transistor 1531 switched by the positive on-duty waveform 1535 or the negative on-duty waveform 1536.

Shown in FIG. 2c, the first polarity of the first high electrical field obtained at the second terminal of the third inductor 1513 is negative or positive respectively with respective to the positive on-duty waveform 1535 or the negative on-duty waveform 1536 switching the transistor 1531, and the second polarity of the second high electrical field obtained at the second terminal of the fourth inductor 1514 is positive or negative respectively with respective to the positive on-duty waveform 1535 or the negative on-duty waveform 1536 switching the transistor 1531.

Squares 15141, 15142, 15143 and 15144 shown in FIG. 2c express with respective to either the positive on-duty waveform or the negative on-duty waveform. An upper square means the positive on-duty waveform and a lower square below the upper square means the negative on-duty waveform. A positive sign or a negative sign in a square respectively stands for a positive polarity or negative polarity at that location. For example, the upper square 15143 surrounding a positive sign shown in FIG. 2c means a positive polarity at the second terminal of the fourth inductor 1514 by the positive on-duty waveform 1535 switching the transistor 1531 and the lower square 15144 below the upper square 15143 surrounding a negative sign shown in FIG. 2c means a negative polarity at the second terminal of the fourth inductor 1514 by the negative on-duty waveform 1536 switching the transistor 1531.

Shown in FIG. 2d, the third polarity of the third high electrical field obtained at a second terminal of the fifth inductor 1523 is positive or negative respectively with respective to the positive on-duty waveform 1535 or the negative on-duty waveform 1536 switching the transistor 1531, and the fourth polarity of the fourth high electrical field obtained at the second terminal of the sixth inductor 1524 is negative or positive respectively with respective to the positive on-duty waveform 1535 or the negative on-duty waveform 1536 switching the transistor 1531.

FIG. 2e has shown the embodiment of FIG. 2a by assigning the transistor as a pnp transistor 1532 switched by the positive on-duty waveform 1535 or the negative on-duty waveform 1536 and FIG. 2j has shown the embodiment of FIG. 2b by assigning the transistor as a pnp transistor 1532 switched by the positive on-duty waveform 1535 or the negative on-duty waveform 1536.

Shown in FIG. 2e, the first polarity of the first high electrical field obtained at a second terminal of the third inductor 1513 is positive or negative respectively with respective to the positive on-duty waveform 1535 or the negative on-duty waveform 1536 switching the pnp transistor 1532, and the second polarity of the second high electrical field obtained at the second terminal of the fourth inductor 1514 is negative and positive respectively with respective to the positive on-duty waveform 1535 or the negative on-duty waveform 1536 switching the pnp transistor 1532.

Shown in FIG. 2j, the third polarity of the third high electrical field obtained at a second terminal of the fifth inductor 1523 is negative or positive respectively with respective to the positive on-duty waveform 1535 or the negative on-duty waveform 1536 switching the pnp transistor 1532, and the fourth polarity of the fourth high electrical field obtained at the second terminal of the sixth inductor 1524 is positive or negative respectively with respective to the positive on-duty waveform 1535 or the negative on-duty waveform 1536 switching the pnp transistor 1532.

Please note that the polarity of a same output of a high electrical field driver is opposite by using different type transistors. For example, the polarity of the second terminal of the third inductor 1513 of the first high electrical field driver of FIG. 2c using npn type transistor 1531 is opposite to the polarity of the second terminal of the third inductor 1513 of the first high electrical field driver of FIG. 2e using pnp type transistor 1532.

Please note that the first polarity is equal to the fourth polarity and the second polarity is equal to the third polarity shown in (FIGS. 2c and 2d), and (FIGS. 2e and 2j).

The first high electrical field driver shown in FIG. 2a and the second high electrical field driver shown in FIG. 2b can be built in a same switching circuit with the transistor disposed between the first inductor and the second inductor. FIG. 2f has shown the high electrical field drivers of FIGS. 2a and 2b having the npn transistor 1532 built in a switching circuit. FIG. 2g has shown the high electrical field drivers of FIG. 2a and FIG. 2b having the pnp transistor 1532 built in a switching circuit. FIGS. 2f and 2g have provided more global view among the first high electrical field driver and the second high electrical field driver. FIGS. 2f and 2g have shown a polarity of an output point changes by using different type transistors.

For the switching circuits of FIG. 2f or 2g having two inductors 151 and 152, a first reaction circuit and a second reaction circuit respectively bypass a first inductor 151 and a second inductor 152. A first reaction circuit comprises a first damper 1512 and a first action/reaction isolation device 1511 electrically connected in series and a second reaction circuit comprises a second damper 1522 and a second action/reaction isolation device 1521 electrically connected in series.

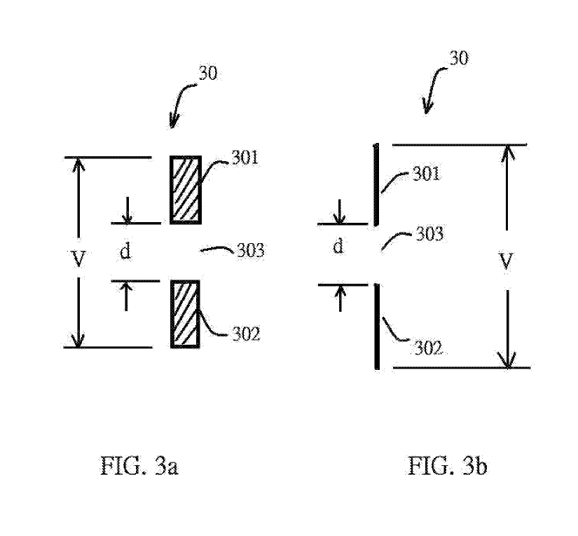

FIG. 3a has shown an open circuit device 30 comprising a first terminal 301 and a second terminal 302 separating the first terminal 301 by an open gap 303 having an open gap width d. The open circuit device 30 is driven by a voltage v. By properly adjusting the voltage v across the open gap 303, the frequency of the voltage v, and the open gap width d, an electrical discharge between the first terminal 301 and the second terminal 302 of the open circuit device 30 can take place and at least one of the first terminal 301 and the second terminal 302 is a discharge electrode of the electrical discharge. The shapes of the first terminal 301 and the second terminal 302 are not limited, for example, the shape can be needle as shown in FIG. 3b or a surface as shown in FIG. 3a. A surface can be viewed as formed by a plurality of needles (or called “micro needle array” in the present invention). The first terminal 301 and the second terminal 302 are not limited, for example, they can be conductors or semiconductors.

The high electrical field produced by the high electrical field driver can drive an open circuit device. Using FIGS. 2f and 2g as examples, the first high electrical field at the second terminal of the third inductor 1513, the second high electrical field at the second terminal of the fourth inductor 1514, the third high electrical field at the second terminal of the fifth inductor 1523 and the fourth high electrical field at the second terminal of the sixth inductor 1524 shown in FIGS. 2f and 2g can respectively drive an open circuit device as respectively shown in FIG. 2h and FIG. 2i.

1. A high electrical field driver, comprising:
an electrical power source;
a first inductor;
a reaction circuit comprising an action/reaction isolation device and a damper electrically connected in series;
a frequency modulator; and
a second inductor having a first terminal and a second terminal;
wherein the electrical power source, the first inductor and the frequency modulator are electrically connected in series with each other, and the reaction circuit is in parallel with the first inductor, and the second inductor forms a transformer with the first inductor for boosting voltage to an expective level, and the first terminal of the second inductor electrically connects to any one of a low side terminal and a high side terminal of the first inductor, and a first high electrical field having a first polarity presents at the second terminal of the second inductor.

2. The high electrical field driver of claim 1, further comprising a third inductor which has a first terminal and a second terminal, wherein the third inductor forms a transformer with the first inductor for boosting voltage to an expective level, and the first terminal of the third inductor electrically connects to the low side terminal or the high side terminal of the first inductor not electrically connecting with the first terminal of the second inductor, and a second high electrical field having a second polarity opposite to the first polarity presents at the second terminal of the third inductor.

3. The high electrical field driver of claim 1, wherein the frequency modulator is a transistor switched by a positive on-duty waveform or a negative on-duty waveform.

4. The high electrical field driver of claim 2, wherein the frequency modulator is a transistor switched by a positive on-duty waveform or a negative on-duty waveform.

5. The high electrical field driver of claim 1, wherein the damper is formed by a PDR device and a NDR device electrically connected in series and the action/reaction isolation device is a capacitor.

6. The high electrical field driver of claim 2, wherein the damper is formed by a PDR device and a NDR device electrically connected in series and the action/reaction isolation device is a capacitor.

7. The high electrical field driver of claim 1, wherein the damper is formed by a PDR device and a NDR device electrically connected in series and the action/reaction isolation device is a diode.

8. The high electrical field driver of claim 2, wherein the damper is formed by a PDR device and a NDR device electrically connected in series and the action/reaction isolation device is a diode.

9. The high electrical field driver of claim 5, wherein the PDR device is a positive temperature coefficient (PTC) and the NDR device is a negative temperature coefficient (NTC).

10. The high electrical field driver of claim 6, wherein the PDR device is a positive temperature coefficient (PTC) and the NDR device is a negative temperature coefficient (NTC).

11. The high electrical field driver of claim 7, wherein the PDR device is a positive temperature coefficient (PTC) and the NDR device is a negative temperature coefficient (NTC).

12. The high electrical field driver of claim 8, wherein the PDR device is a positive temperature coefficient (PTC) and the NDR device is a negative temperature coefficient (NTC).

13. The high electrical field driver of claim 3, wherein the damper is formed by a PDR device and a NDR device electrically connected in series and the action/reaction isolation device is a capacitor.

14. The high electrical field driver of claim 4, wherein the damper is formed by a PDR device and a NDR device electrically connected in series and the action/reaction isolation device is a capacitor.

15. The high electrical field driver of claim 3, wherein the damper is formed by a PDR device and a NDR device electrically connected in series and the action/reaction isolation device is a diode.

16. The high electrical field driver of claim 4, wherein the damper is formed by a PDR device and a NDR device electrically connected in series and the action/reaction isolation device is a diode.

17. The high electrical field driver of claim 13, wherein the PDR device is a positive temperature coefficient (PTC) and the NDR device is a negative temperature coefficient (NTC).

18. The high electrical field driver of claim 14, wherein the PDR device is a positive temperature coefficient (PTC) and the NDR device is a negative temperature coefficient (NTC).

19. The high electrical field driver of claim 15, wherein the PDR device is a positive temperature coefficient (PTC) and the NDR device is a negative temperature coefficient (NTC).

20. The high electrical field driver of claim 16, wherein the PDR device is a positive temperature coefficient (PTC) and the NDR device is a negative temperature coefficient (NTC).

21. 1. A high electrical field driver, comprising:
an electrical power source;
a first inductor;
a second inductor;
a first reaction circuit comprising a first PDR device, a first NDR device, and a first capacitor electrically connected in series with each other;
a second reaction circuit comprising a second PDR device, a second NDR device, and a second capacitor electrically connected in series with each other;
a transistor switched by a positive on-duty waveform or a negative on-duty waveform;
a third inductor having a first terminal and a second terminal;
a fourth inductor having a first terminal and a second terminal;
a fifth inductor having a first terminal and a second terminal; and
a sixth inductor having a first terminal and a second terminal;
wherein the electrical power source, the first inductor, the transistor, the second inductor are electrically connected in series with each other with the transistor disposed between the first inductor and second inductor, and the first reaction circuit is in parallel with the first inductor and the second reaction circuit is in parallel with the second inductor, and a third inductor forms a transformer with the first inductor for boosting voltage to an expective level, and a first terminal of the third inductor electrically connects with a low side terminal of the first inductor, and a first high electrical field with a first polarity is obtained at the second terminal of the third inductor; and a fourth inductor forms a transformer with the first inductor for boosting voltage to an expective level, and a first terminal of the fourth inductor electrically connects with a high side terminal of the first inductor, and a second high electrical field with a second polarity opposite to the first polarity can be obtained at the second terminal of the fourth inductor; and a fifth inductor forms a transformer with the second inductor for boosting voltage to an expective level, and a first terminal of the fifth inductor electrically connects with a low side terminal of the second inductor, and a third high electrical field with the second polarity is obtained at the second terminal of the fifth inductor; and a sixth inductor forms a transformer with the second inductor for boosting voltage to an expective level, and a first terminal of the sixth inductor electrically connects with a high side terminal of the second inductor, and a fourth high electrical field with the first polarity is obtained at the second terminal of the sixth inductor.

22. The high electrical field driver of claim 21, wherein the first PDR device and the second PRD device are respectively a first positive temperature coefficient (PTC) and a second positive temperature coefficient (PTC), and the first NDR device and the second NRD device are respectively a first negative temperature coefficient (NTC) and a second negative temperature coefficient (NTC).
